(19) United States
(12) Patent Application Publication
(10) Pub. No.: US 2026/0112269 A1
(43) Pub. Date: Apr. 23, 2026

(54) SYSTEM AND METHOD FOR PROVIDING PARKING INFORMATION

(71) Applicant: HYUNDAI MOBIS CO., LTD., Seoul (KR)

(72) Inventor: TAEJIN KIM, Yongin-si (KR)

(73) Assignee: HYUNDAI MOBIS CO., LTD., Seoul (KR)

(21) Appl. No.: 19/231,097

(22) Filed: Jun. 6, 2025

(30) Foreign Application Priority Data
Oct. 21, 2024 (KR) 10-2024-0143666

(51) Int. Cl. G08G 1/14; G01C 21/36; G06K 7/14; G06K 19/06

(52) U.S. Cl. CPC G08G 1/143; G01C 21/3685; G06K 7/1417; G06K 19/06037

(57) ABSTRACT

A parking information providing system for providing parking information of a parking lot to a vehicle includes a server to receive parking lot-related data from an external source, generate parking information based on the parking lot-related data, and output a quick response (QR) code containing the parking lot-related information; and a QR code recognition unit mounted in the vehicle and including a camera to recognize the QR code. The server generates real-time parking information based on the parking lot-related data.

### CROSS-REFERENCE TO RELATED APPLICATION

The present application claims priority to Korean Patent Application No. 10-2024-0143666, filed on Oct. 21, 2024, the entire contents of which is incorporated herein for all purposes by this reference.

### BACKGROUND

### Field of the Invention

The present invention relates to a system and a method for providing parking information using a dynamic quick response (QR) code.

### Description of the Related Art

In conventional parking lots, information such as whether the lot is full and the availability of parking spaces is displayed using electronic boards located at the entrance or LED indicators installed at individual parking spots. In the case of electronic boards located at the entrance, they display whether the lot is full and the number of available spaces, but due to the unique characteristics of each parking lot and real-time changes in status, it is difficult to provide accurate information to vehicles. Furthermore, in the case of LED indicators installed at each parking space, drivers must look around the area to locate an available space, which can be inconvenient. In addition, parking space and information may be provided through systems linked with vehicles and mobile phones, but such methods require predefined communication protocols and the installation of separate apps, resulting in inconvenience, and may also involve complex issues in integrating with the vehicle.

### DOCUMENTS OF RELATED ART

(Patent Document 1) Korean Registered Patent No. 10-1877736 (“CCTV System with Improved Patrol Monitoring Function,” Registration Date: Jul. 6, 2018)

### SUMMARY

The present invention has been conceived to solve the above problems, and it is an object of the present invention provide a system and method for providing parking information, which are capable of directly providing parking lot information and parking location information to vehicles entering the parking lot by using dynamically changing QR codes.

In order to accomplish the above object, a system for providing parking information of a parking lot to a vehicle includes a server configured to receive parking lot-related data from an external source, generate parking information based on the parking lot-related data, and output a quick response (QR) code containing the parking information, and a QR code recognition unit mounted in the vehicle and including a camera configured to recognize the QR code, wherein the server is configured to generate real-time parking information based on the parking lot-related data.

The server may provide the real-time parking information to the vehicle connected via the QR code in at least one of a text format, an image format, and a voice format.

The server may generate an image including the real-time parking information, generate a link accessible to the image, and convert the link into the QR code.

The real-time parking information may include at least one of a number of parked vehicles, a number of available parking spaces, floor levels with available parking, and routes in the parking lot.

The QR code may include an error correction function configured to restore the real-time parking information when at least a portion of the QR code is damaged.

The QR code recognition unit may recognize and interpret the QR code, and transmit the real-time parking information included in the QR code to at least one of a head-up display (HUD), a cluster, and an audio-video navigation (AVN) monitor of the vehicle.

The server may generate a link including the real-time parking information and convert the link into the QR code, and the QR code recognition unit may recognize and interpret the QR code and control the vehicle to connect to a parking lot server of the parking lot, allowing the vehicle to perform parking based on the real-time parking information.

In order to accomplish the above object, a method for providing parking information in a parking information providing system including a server and a QR code recognition unit includes (a) receiving, at the server, parking lot-related data from an external source, (b) generating parking information based on the parking lot-related data, (c) generating and outputting a quick response (QR) code including the parking information, and (d) recognizing, at the QR code recognition unit, the QR code, wherein (b) includes generating real-time parking information based on the parking lot-related data.

Operation (b) may include generating, at the server, the real-time parking information in at least one of a text format, an image format, and a voice format.

Operation (b) may include generating, at the server, an image including the real-time parking information, and operation (c) may include generating a link accessible to the image and converting the link into the QR code.

The real-time parking information may include at least one of a number of parked vehicles, a number of available parking spaces, floor levels with available parking, and routes in the parking lot.

The QR code may include an error correction function configured to restore the real-time parking information when at least a portion of the QR code is damaged.

Operation (d) may include recognizing and interpreting, at the QR code recognition unit, the QR code and transmitting the real-time parking information included in the QR code to at least one of a head-up display (HUD), a cluster, and an audio-video navigation (AVN) monitor of the vehicle.

Operation (c) may include generating, at the server, a link including the real-time parking information and converting the link into the QR code, and operation (d) may include recognizing and interpreting, at the QR code recognition unit, the QR code to control the vehicle to connect to a parking lot server based on the real-time parking information, allowing the vehicle to perform parking.

### BRIEF DESCRIPTION OF THE DRAWINGS

FIG. 1 is a schematic diagram illustrating a parking information providing system according to the present invention;

FIG. 2 is a schematic diagram illustrating real-time parking information of the parking information providing system according to the present invention;

FIG. 3 is a schematic diagram illustrating an alternative form of real-time parking information compared to FIG. 2;

FIG. 4 is a flowchart illustrating a method for providing parking information of the parking information providing system according to the present invention.

### DETAILED DESCRIPTION

To explain the present invention, its operational advantages, and the objectives achieved through its implementation, preferred embodiments of the present invention are illustrated and described below with reference thereto.

First, the terms used in this application are merely intended to describe specific embodiments and are not intended to limit the scope of the present invention, and singular expressions may include plural expressions unless the context clearly indicates otherwise. Additionally, in this application, terms such as “comprising” or “having” are intended to indicate the presence of the features, numbers, steps, operations, components, parts, or combinations thereof described in the specification, but do not preclude the presence or addition of one or more other features, numbers, steps, operations, components, parts, or combinations thereof.

In describing the present invention, detailed descriptions of well-known configurations or functions may be omitted so as not to obscure the subject matter of the invention.

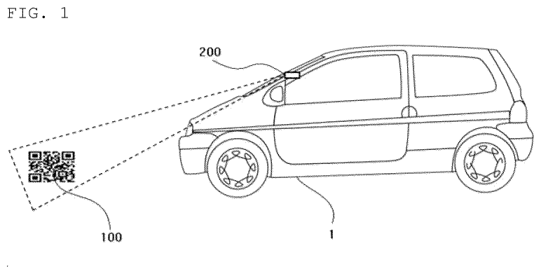

FIG. 1 is a schematic diagram illustrating a parking information providing system according to the present invention.

As shown in FIG. 1, a parking information providing system according to the present invention refers to a system configured to provide parking lot information to a vehicle 1, and may include a server (not shown) and a QR code recognition unit 200.

The server may receive data related to the parking lot from an external source. Based on the received parking lot-related data, the server may generate parking information and output a QR code 100 including the generated parking information to the outside.

Here, the server may generate real-time parking information based on the received parking lot-related data. Accordingly, the QR code 100 may change dynamically as the status of the parking lot changes.

In addition, the server may output the QR code 100 including real-time parking information to the outside, and the output QR code 100 may be provided in various forms. Specifically, the QR code 100 may be provided using laser projection advertising. Alternatively, the QR code 100 may be provided externally using a large liquid crystal display (LCD) or light emitting diode (LED) display. However, this is merely one embodiment and is not limited thereto.

The QR code recognition unit 200 may be mounted on the vehicle 1 and may recognize the QR code 100 provided by the server. Specifically, the QR code recognition unit 200 may include a camera, configured to recognize and interpret the QR code 100 and provide the decoded information to an internal device of the vehicle 1. Here, the camera may include at least one of a front-facing camera or an around-view monitoring (AVM) system camera.

Hereinafter, the components of the parking information system of the present invention and their interactions will be described in detail.

First, the server may receive data related to the parking lot from an external source and generate real-time parking information, which may include at least one of the number of parked vehicles, the number of available parking spaces, the floor levels with available parking, and the routes, and include the information within a QR code 100. Additionally, through the QR code 100, the generated real-time parking information may be provided to the vehicle 1 in at least one format among text, image, and voice. In this case, the QR code recognition unit 200 may recognize and interpret the QR code 100, and transmit the real-time parking information included in the QR code 100 to at least one of the head-up display (HUD), the cluster, and the audio video navigation (AVN) monitor of the vehicle 1.

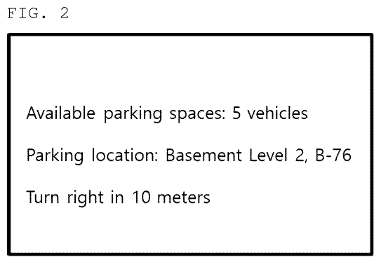

FIG. 2 is a schematic diagram illustrating real-time parking information of the parking information providing system according to the present invention.

As shown in FIG. 2, when the vehicle 1 recognizes the QR code 100, real-time parking information may be provided in text form.

Specifically, the real-time parking information may include floor levels with available parking, parking lot pillar numbers, and a simple route guide, and the QR code recognition unit 200 may recognize and interpret the QR code 100, transmit the information in text form to at least one of the vehicle's head-up display, cluster, or AVN monitor, such that the real-time parking information may be displayed on at least one of the head-up display, cluster, or AVN monitor of the vehicle 1.

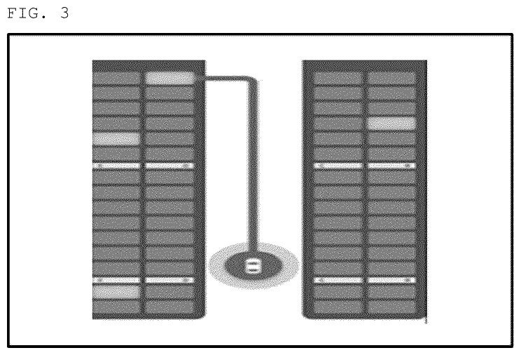

FIG. 3 is a schematic diagram illustrating an alternative form of real-time parking information compared to FIG. 2.

As shown in FIG. 3, when the vehicle 1 recognizes the QR code 100, the real-time parking information may be provided in the form of an image.

Specifically, the real-time parking information may include an overall view of the parking lot, including its structure and information on vacant parking spaces, and a route to those spaces may also be provided. The QR code recognition unit 200 may recognize and interpret the QR code 100 and transmit the decoded information in image form to at least one of a head-up display (HUD), a cluster, or an AVN monitor of the vehicle 1, such that the real-time parking information may be displayed on at least one of the cluster or AVN monitor of the vehicle 1. This allows more detailed information to be provided to the driver compared to when only text is offered. However, embedding image information directly into the QR code 100 may be difficult. In this case, the server may generate an image including real-time parking information, create a link to access the generated image, and convert the link into the QR code 100 for external provision. Accordingly, this case may apply when the vehicle has Internet connectivity.

Additionally, the parking information providing system 1000 according to the present invention may allow the vehicle 1 to autonomously park.

Specifically, the server may generate a link including real-time parking information and convert the link into the QR code 100. The QR code recognition unit 200 may recognize and interpret the QR code 100 to provide the link to the vehicle 1, and the vehicle 1 may be controlled to connect to the parking lot server via the link. As a result, the vehicle may automatically park based on real-time parking information from the parking lot server.

Meanwhile, the QR code 100 has various error correction levels, which allow information to be recovered even when the code is damaged or partially obscured. These levels may be categorized into four grades (L, M, Q, H) based on the data recovery capability. In the case of the QR code 100 of the present invention, since high accuracy in parking location information is important, it is preferable to use the high (H) level, which includes 30% error correction capability.

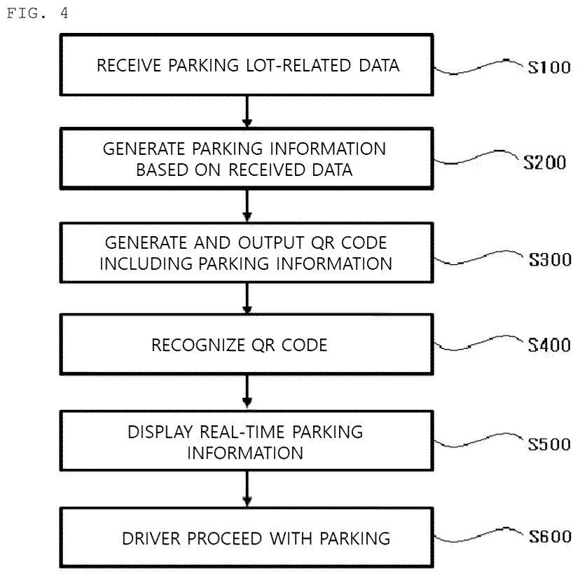

FIG. 4 is a flowchart illustrating a method for providing parking information of the parking information providing system according to the present invention.

As shown in FIG. 4, a method for providing parking information in the parking information providing system 1000 including a server and a QR code recognition unit 200, according to the present invention, may include receiving, at the server, parking lot-related data from an external source in operation S100, generating parking information based on the received data in operation S200, generating and outputting a QR code 100 including the parking information in operation S300, and recognizing, at the QR code recognition unit 200, the QR code 100 in operation S400.

In operation S200, the server may generate real-time parking information based on the received data.

Specifically, the server may receive parking lot-related data from an external source in operation S100, generate, in operation S200, real-time parking information including at least one of the number of parked vehicles, available parking spaces, floor levels with available parking, and routes, and generate, in operation S300, the QR code 100 containing the generated information. Additionally, in operation S200, the real-time parking information generated through the QR code 100 may be provided to the vehicle 1 in at least one of text, image, or voice formats. In this case, the QR code recognition unit 200 may recognize and decode the QR code 100 in operation S400, and transmit the real-time parking information included in the QR code 100 to at least one of the vehicle's HUD, cluster, and AVN monitor.

As one example, when the vehicle 1 recognizes the QR code 100, the real-time parking information may be provided in the form of an image.

Specifically, the real-time parking information may include an overall view of the parking lot, including its structure and information on vacant parking spaces, and a route to those spaces may also be provided. The QR code recognition unit 200 may recognize and interpret the QR code 100 and transmit the decoded information in image form to at least one of a HUD, a cluster, or an AVN monitor of the vehicle 1, such that the real-time parking information may be displayed on at least one of the HUD, cluster, and AVN monitor of the vehicle 1. This allows more detailed information to be provided to the driver compared to when only text is offered. However, embedding image information directly into the QR code 100 may be difficult. In this case, the server may generate, in operation S200, an image including the real-time parking information, generate, in operation S300, a link for accessing the generated image, and convert the link into the QR code 100 for provision. Accordingly, this case may apply when the vehicle has Internet connectivity.

Additionally, the parking information providing system 1000 according to the present invention may allow the vehicle 1 to autonomously park.

Specifically, the server may generate, in operation S300, a link including the real-time parking information and convert the link into the QR code 100. In operation S400, the QR code recognition unit 200 may recognize and interpret the QR code 100 to provide the link to the vehicle 1, and the vehicle 1 may be controlled to connect to the parking lot server via the link. As a result, the vehicle may automatically park based on real-time parking information from the parking lot server.

Meanwhile, the QR code 100 has various error correction levels, which allow information to be recovered even when the code is damaged or partially obscured. These levels may be categorized into four grades (L, M, Q, H) based on the data recovery capability. In the case of the QR code 100 of the present invention, since high accuracy in parking location information is important, it is preferable to use the high (H) level, which includes 30% error correction capability.

A system and method for providing parking information according to various embodiments of the present invention are advantageous in facilitating the provision of parking information directly to vehicles using simple equipment in parking lots operating under various environments and systems.

The parking information providing system and method are also advantageous in enabling more efficient parking by assigning parking spaces to individual vehicles based on dynamically changing information.

Furthermore, the parking information providing system and method are advantageous in facilitating data transmission for automatic parking through the implementation of a system linked with future autonomous parking systems.

While preferred embodiments of the present invention have been described above, the embodiments disclosed herein are intended to be illustrative and not limiting of the scope of the invention. Accordingly, the technical scope of the invention is not limited to the disclosed embodiments but encompasses combinations of the disclosed embodiments, and the scope of the invention is not limited by these embodiments. Furthermore, it will be apparent to those skilled in the art that various changes and modifications can be made to the present invention without departing from the spirit or scope of the attached claims, and all such variations and modifications are intended to fall within the scope of the present invention.

### DESCRIPTION OF REFERENCE NUMERALS

1: vehicle
1000: parking information providing system
100: QR code
200: QR code recognition unit

What is claimed is:

1. A system for providing parking information of a parking lot to a vehicle, the system comprising:
a server configured to receive parking lot-related data from an external source, generate parking information based on the parking lot-related data, and output a quick response (QR) code containing the parking information; and
a QR code recognition unit mounted in the vehicle and including a camera configured to recognize the QR code,
wherein the server is configured to generate real-time parking information based on the parking lot-related data.

2. The system of claim 1, wherein the server is configured to provide the real-time parking information to the vehicle connected via the QR code in at least one of a text format, an image format, and a voice format.

3. The system of claim 2, wherein the server is configured to generate an image including the real-time parking information, generate a link accessible to the image, and convert the link into the QR code.

4. The system of claim 1, wherein the real-time parking information comprises at least one of a number of parked vehicles, a number of available parking spaces, floor levels with available parking, and routes in the parking lot.

5. The system of claim 1, wherein the QR code comprises an error correction function configured to restore the real-time parking information when at least a portion of the QR code is damaged.

6. The system of claim 1, wherein the QR code recognition unit is configured to recognize and interpret the QR code, and to transmit the real-time parking information included in the QR code to at least one of a head-up display (HUD), a cluster, and an audio-video navigation (AVN) monitor of the vehicle.

7. The system of claim 1, wherein the server is configured to generate a link including the real-time parking information and convert the link into the QR code, and the QR code recognition unit is configured to recognize and interpret the QR code and control the vehicle to connect to a parking lot server of the parking lot, allowing the vehicle to perform parking based on the real-time parking information.

8. A method for providing parking information in a parking information providing system including a server and a QR code recognition unit, the method comprising:
(a) receiving, at the server, parking lot-related data from an external source;
(b) generating parking information based on the parking lot-related data;
(c) generating and outputting a quick response (QR) code including the parking information; and
(d) recognizing, at the QR code recognition unit, the QR code,
wherein (b) comprises generating real-time parking information based on the parking lot-related data.

9. The method of claim 8, wherein (b) comprises generating, at the server, the real-time parking information in at least one of a text format, an image format, and a voice format.

10. The method of claim 9, wherein (b) comprises generating, at the server, an image including the real-time parking information, and (c) comprises generating a link accessible to the image and converting the link into the QR code.

11. The method of claim 8, wherein the real-time parking information comprises at least one of a number of parked vehicles, a number of available parking spaces, floor levels with available parking, and routes in the parking lot.

12. The method of claim 8, wherein the QR code comprises an error correction function configured to restore the real-time parking information when at least a portion of the QR code is damaged.

13. The method of claim 8, wherein (d) comprises recognizing and interpreting, at the QR code recognition unit, the QR code and transmitting the real-time parking information included in the QR code to at least one of a head-up display (HUD), a cluster, and an audio-video navigation (AVN) monitor of the vehicle.

14. The method of claim 8, wherein (c) comprises generating, at the server, a link including the real-time parking information and converting the link into the QR code, and (d) comprises recognizing and interpreting, at the QR code recognition unit, the QR code to control the vehicle to connect to a parking lot server based on the real-time parking information, allowing the vehicle to perform parking.
